(19) United States
(12) Patent Application Publication
(10) Pub. No.: US 2024/0247717 A1
(43) Pub. Date: Jul. 25, 2024

(54) METHOD FOR ROLLING AN ELECTRICALLY DRIVEN VEHICLE INTO A PARKING LOCK DEVICE

(71) Applicant: Robert Bosch GmbH, Stuttgart (DE)

(72) Inventors: Gerhard Wetzel, Korntal-Muenchingen (DE); Takashi Shigematsu, Yokohama (JP)

(21) Appl. No.: 18/565,819

(22) PCT Filed: Apr. 26, 2022
(86) PCT No.: PCT/EP2022/061039

§ 371 Date: Nov. 30, 2023

(30) Foreign Application Priority Data
Jun. 1, 2021 (DE) 10 2021 205 592.3

(51) Int. Cl. F16H 63/34; B60L 15/20; F16H 59/68; F16H 63/50

(52) U.S. Cl. CPC F16H 63/3425; B60L 15/20; F16H 59/68; F16H 63/50

(57) ABSTRACT

The invention relates to a method for rolling an electrically driven vehicle (10) into a parking lock device (44) from a position in which a pawl (48) is prevented from locking a parking lock gear (46). When the parking lock device (44) is activated, a biasing spring (54) is biased by an actuator (52). A position, identified by position sensing (36), of a parking lock gear (46) accommodated in a rotationally fixed manner is then sent to a control unit (40). Subsequently, an angle of rotation of the rotor shaft (34) of an electric motor (14) which is required to reach the nearest tooth space (60) of an outer toothing (56) of the parking lock gear (46) is determined. The electric motor (14) is then activated in order for the determined angle of rotation to be swept and a controlled approach to be made to the position of the determined closest tooth space (60). The invention further relates to the use of the method for rolling an electrically driven vehicle (10) into a parking lock device (44) from a position in which a pawl (48) is prevented from locking a parking lock gear (46).

### BACKGROUND

The invention relates to a method for rolling an electrically driven vehicle into a parking lock device from a position in which a pawl is prevented from locking a parking lock gear. Furthermore, the invention relates to the use of the method for rolling an electrically driven vehicle into a parking lock device.

DE 10 2015 217 975 A1 relates to a method for designing a parking lock of a dual-clutch transmission of a vehicle. The dual-clutch transmission comprises a parking lock. In order to design the parking lock of a dual clutch transmission of a vehicle, a torque request is issued when a road inclination is detected and a powershift clutch of the dual clutch transmission is closed when a gear is engaged in the partial transmission to which the powershift clutch is assigned. The powershift clutch to be engaged and the required torque are selected in such a way that the torque counteracts the torque applied to the transmission on the output side via the drive gears when the parking lock is engaged, which is supported by the locking pawl, and serves as a relief torque.

DE 10 2011 079 618 A1 relates to a parking lock that has a parking lock gear with toothing and a locking pawl. The locking pawl can be moved relative to the parking lock gear in such a way that it blocks or releases the parking lock gear. The parking lock gear can be moved by a drive that operates independently of the adjustment mechanism. Before or during engagement or disengagement of the parking lock by means of the drive, the parking lock gear is repositioned relative to the locking pawl, wherein the parking lock gear is subjected to torque. This reduces the insertion or removal forces to be applied by the adjustment mechanism.

DE 10 2009 030 084 B4 relates to a method for releasing a parking lock of a motor vehicle. The parking lock is first activated by means of a control variable to release the parking lock. This involves setting a drive torque that counteracts a downhill drive torque as a function of a control variable. A downhill drive torque is determined using a characteristic measured variable as a function of the control variable, which acts on the locked wheels by means of the parking lock. A drive torque that counteracts the downhill torque is set depending on the measured variable. The drive torque is set against the approach direction if the approach direction and the downhill drive direction are in the same direction, wherein the downhill drive torque exceeds the drive torque during release and/or during stopping or, alternatively, the drive torque is set in the approach direction if this and the downhill drive direction are in opposite directions to each other.

Today, parking locks are used in most automatic transmissions to prevent the vehicle from rolling away unintentionally. Parking locks are also installed in the transmission downstream of the electric motor in electrically driven vehicles. If a vehicle equipped with a parking lock is parked on a slope or downhill section, the following situation may arise:

The driver brakes the vehicle to a standstill using the brake system and then activates the parking lock. The parking lock actuator then actuates the pawl via a mechanism to insert it into a gap in the parking lock gear. It can happen that the tooth of the pawl hits the tooth of the parking lock gear and locking is impossible. In this case, a spring is biased in such a way that it presses the pawl onto the parking lock gear. When the driver releases the brakes, the vehicle starts to roll forwards or backwards, depending on whether it is on a downhill or uphill section of the route. The rolling of the vehicle turns the drive gears, the transmission and thus also the parking lock gear coupled to it. The pressed pawl engages in the next gap of the parking lock gear due to the effect of the spring biasing. However, this causes the vehicle to stop abruptly, resulting in vibrations and torques that put mechanical stress on the components in the drivetrain, but can also lead to a reduction in noise and comfort for the driver. In order to make this abrupt stop more gentle, DE 10 2017 118 517 A1 and US 2018/0043895 A1 propose slowly reducing the applied brake pressure and thus slowly rolling the vehicle into the parking lock.

### SUMMARY

According to the invention, a method is proposed for rolling an electrically driven vehicle into a parking lock device from a position in which a pawl is prevented from locking a parking lock gear, wherein the following method steps are carried out:
biasing of a biasing spring by an actuator when the parking lock device is activated,
transmission to a control unit of a position of a parking lock gear accommodated in a rotationally fixed manner, sensed by position sensing system,
determination of the angle of rotation of the rotor shaft of an electric motor to reach the nearest tooth space of an outer toothing of the parking lock gear and
Control of the electric motor for sweeping the angle of rotation determined in accordance with c) and a controlled approach to the position of the tooth space determined in accordance with c).

In the manner described above, a gentle rolling of the vehicle can be achieved without the need for additional sensor technology if the electrically driven vehicle is parked on an incline or downhill section and a tooth-on-tooth position is present on the parking lock device. The brake pressure or the gradient of the brake pressure reduction is not used, and no additional sensors or other additional parts are required. Finally, there is the advantageous possibility of cost-effective and simple realisation.

In a further development of the method proposed according to the invention, a direction of rotation of the electric motor for sweeping the angle of rotation determined according to c) is determined in the control unit of the electrically driven vehicle from the information as to whether the electric motor has delivered a torque before reaching the standstill position of the electrically driven vehicle, or whether the electric motor was rotated or dragged by the vehicle movement before reaching the standstill position of the electrically driven vehicle in recuperation mode.

Using existing components, both the angle of rotation to reach the nearest tooth spaces and the direction of rotation in which the electric motor is to be moved can be determined without the need for additional hardware components.

In an advantageous further development of the method proposed according to the invention, the rotary movement of the pawl about an axis of rotation is brought about by a translatory movement of an actuating mechanism. This makes it possible to realise short actuating paths in an advantageous way, so that the actuator of the parking lock device can be designed accordingly.

In a further advantageous embodiment of the method proposed according to the invention, the biasing of the biasing spring according to a) is transferred to a translationally movable slider of the actuating mechanism of the parking lock device, so that the latter is set against an actuating surface having a wedge-shaped contact surface.

In a further advantageous embodiment of the method proposed according to the invention, the position of the parking lock gear according to b) is detected by means of a position sensing system designed as a resolver. This is an advantageous way of ensuring reliable signal acquisition.

In a further advantageous embodiment of the method proposed according to the invention, the pawl is held in a position set against the outer toothing of the parking lock gear while method steps a) through d) are being carried out. This ensures that as soon as the information in the control unit regarding the angle of rotation and the direction of rotation of the electric motor is determined, the parking lock can be locked immediately in the next available tooth space of the outer toothing of the parking lock gear without any further delays in the signal chain.

In a further, advantageous embodiment of the method proposed according to the invention, the pawl is locked there by the slider of the actuating mechanism after engaging in the nearest tooth space of the outer toothing according to c), so that the vehicle remains reliably secured in its parked position.

In the method proposed according to the invention, the pawl is unlocked, i.e. released again, by a translatory movement of the slider once the parking lock device has been activated again after the controlled rolling movement has been carried out.

Furthermore, the invention relates to the use of the method for rolling an electrically driven vehicle into a parking lock device from a position in which a pawl is prevented from locking the parking lock gear.

In contrast to the known methods, in which the brake pressure can be used to execute a rolling movement and is slowly reduced during the rolling process, the method proposed according to the invention does not require the use of brake pressure. With electrically driven vehicles, the driver can only bring the vehicle to a standstill using one-pedal operation, as the electrically driven vehicle is braked by the drag torque applied by the electric motor if the accelerator pedal is not depressed, i.e. it is not absolutely necessary to apply the brake to decelerate. If the situation arises in this driving position and in this driving mode, i.e. one-pedal operation, that the electrically driven vehicle comes to a standstill on an uphill or downhill gradient and there is a tooth-to-tooth position on the parking lock, the method proposed in accordance with the invention can be used to achieve a gentle rolling of the vehicle. This is achieved without additional sensors by using components already known for detecting the position of the parking lock gear, for example in the form of a resolver. This allows a reliable rotational position of the parking lock gear to be determined on the one hand, and on the other hand, the direction of rotation of the electric motor is used to determine whether the electric motor supplied a torque before the vehicle came to a standstill or whether a torque was applied to it by the vehicle movement in towing mode. From the position sensing and the known geometry of the outer toothing of the parking lock gear, the nearest tooth space in the outer toothing of the parking lock gear can be determined without the use of additional hardware.

Based on the now known angle of rotation of the rotor shaft, on the circumference of which the parking lock gear is fastened in a rotationally fixed manner, and the known direction of rotation of the electric motor, it is now possible to achieve controlled rolling of the electrically driven vehicle into the parking lock.

A further advantage of the method proposed according to the invention is that the method can also be retrofitted to vehicles that have already been delivered as an update with regard to the software and can therefore also improve the driving comfort of vehicles that have already been delivered.

### BRIEF DESCRIPTION OF THE DRAWINGS

Embodiments of the invention are explained in greater detail with reference to the drawings and the following description.

Here:

FIG. 1 shows the components of the electric drivetrain of an electrically driven vehicle,

FIG. 2a a parking lock device of an electrically driven vehicle with a tooth-on-tooth position between the outer toothing and the pawl, and

FIG. 2b a pawl of a parking lock device inserted into a tooth space of the outer toothing.

### DETAILED DESCRIPTION

In the following description of the embodiments of the invention, identical or similar elements are denoted by identical reference numbers, wherein a repeated description of these elements is omitted in individual cases. The figures illustrate the subject-matter of the invention merely schematically.

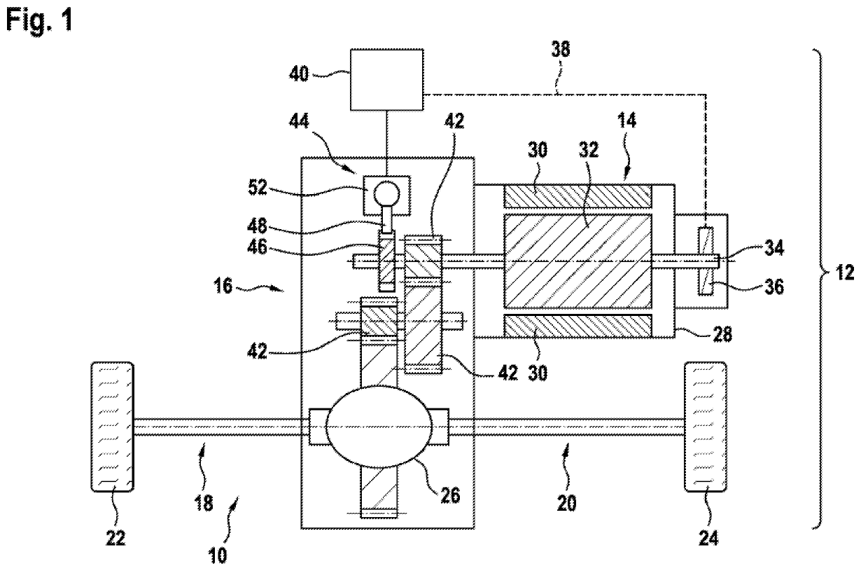

FIG. 1 shows a schematic diagram of an electric drivetrain 12 of an electrically driven vehicle 10. The electrically driven vehicle 10 comprises the electric drivetrain 12, which contains an electric motor 14 and a transmission 16. A first drive shaft 18 with a first drive gear 22 and a second drive gear 24 is driven via the transmission 16. An axle differential 26 is located inside the transmission 16. A housing 28 is flange-mounted on the side of the transmission 16, in which a stator 30 of the electric motor 14 is accommodated. A rotor 32 of the electric motor accommodated in a rotor shaft 34 rotates in the stator 30.

As can also be seen from the representation according to FIG. 1, the electric motor 14, in particular its rotor shaft 34, is assigned a position detecting 36, which can be designed, for example, as a resolver attached to the outside of the housing 28. The position detecting 36 is connected to a control unit 40 in the electric drivetrain 12 via a signal connection 38.

FIG. 1 also shows that a number of gearwheels 42 are accommodated in the transmission 16, which convert the rotational movement of the rotor 32 of the electric motor 14 into a drive torque according to the respective transmission ratio(s).

Furthermore, a parking lock device 44 is associated with the transmission 16 as shown in FIG. 1. The parking lock device 44 comprises a parking lock gear 46, which is accommodated in a rotationally fixed manner, for example, in the rotor shaft 34 of the electric motor 14. Alternatively, the parking lock gear 46 can also be located on a shaft in the transmission 16, on an intermediate shaft or on the axle differential 26. Furthermore, the parking lock device 44 comprises a pawl 48, which engages in an outer toothing 56 formed on the circumference of the parking lock gear 46 and blocks it when actuated. The parking lock device 44 is actuated by an actuator 52, which in turn is controlled by the control unit 40.

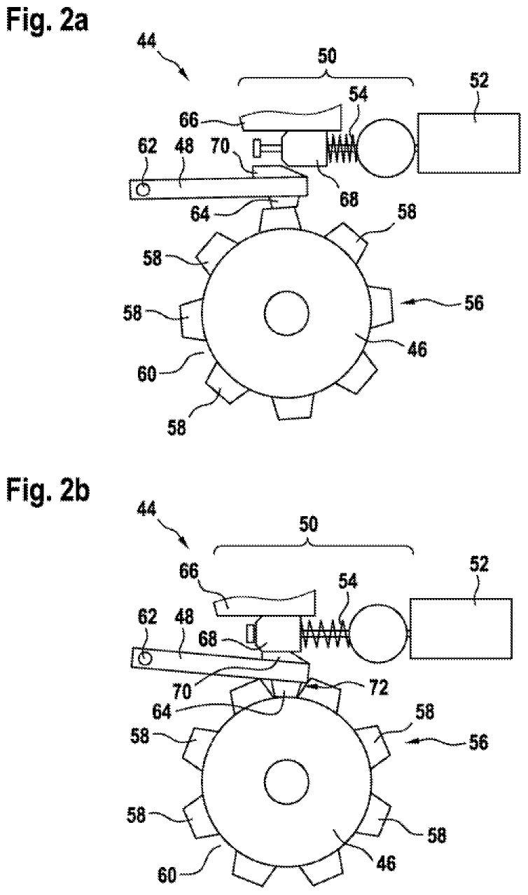

The illustration in FIG. 2a shows a position of the parking lock device 44 in which a tooth-on-tooth position is reached when an electrically driven vehicle 10 comes to a standstill, whether on a downhill or uphill gradient. In the present context, this means that a pawl tooth 64 of a pawl 48, which is movable about an axis of rotation 62, lies on a tooth 58 of the outer toothing 56 on the outer circumference of the parking lock gear 46, and therefore cannot engage in a tooth space 60 formed between two neighbouring teeth 58 of the outer toothing 56, thus blocking the rotary movement of the parking lock gear 46. This state of the parking lock device 44 is shown in FIG. 2a. An actuation mechanism 50 of the parking lock device 44 is located above the pawl 48, which can be swivelled about the axis of rotation 62. In addition to a biasing spring 54, this comprises a slider 68, which can be moved in translation and is guided in translation along a guide 66. The slider 68 acts on an adjusting surface 70, which can be designed as a wedge, for example, and is located on the upper side of the pawl 48, which can be swivelled about the axis of rotation 62.

FIG. 2b shows a state in which a rotary movement and thus a plunging movement 72 is forced on the pawl 48, which is movable about the axis of rotation 62, via the slider 68 by biasing the biasing spring 54. In the state shown in FIG. 2b, the translatory movement of the slider 68 along the guide 66 causes the actuating surface 70 to be traversed in the form of a wedge, so that the pawl tooth 64 of the pawl 48 is retracted into the tooth space 60 and the rotary movement of the parking lock gear 46 remains blocked at the outer toothing 56 formed on the outer circumference. As long as the slider 68 is in the position shown in FIG. 2b, the pawl tooth 64 of the pawl 48 remains retracted into the tooth space 60 of two neighbouring teeth 58 of the outer toothing 56 in accordance with the plunging movement 72 and is also locked there.

The transition from the state in the position according to FIG. 2a, which shows a tooth-on-tooth position of the parking lock device 44, to an activated, i.e. blocked state of the parking lock device 44, is achieved by applying the method proposed according to the invention.

The position detecting 36 is connected to the control unit 40 via the signal connection 38. The control unit 40 can be used to control the entire electric drivetrain 12, but a separate control unit 40 can also be used for this purpose.

The rotor shaft 34 of the electric motor 14 transmits the torque of the electric motor 14 to the transmission 16. This is where the torque conversion takes place via the gearwheels 42. The torque is transmitted to the drive gears 22 and 24 via the axle differential 26 via the drive shafts 18, 20. The parking lock device 44 is located in the transmission 16.

The parking lock gear 46 of the parking lock device 44 is, for example, connected to the rotor shaft 34 or the rotor 32 of the electric motor 14 in such a way that a rotary movement, which is detected by the position detecting 36 in the form of a resolver, also leads to a corresponding rotation of the parking lock gear 46. This means that the position of the parking lock gear 46, which can be accommodated in a rotationally fixed manner in the rotor shaft 34 or in an intermediate shaft, can be clearly assigned to a signal of the position detecting 36. This makes it possible to determine the exact position of the parking lock gear 46 from the position detection signal 36.

If the electrically driven vehicle 10 now comes to a standstill on an uphill or downhill gradient and the parking lock device 44 is actuated by the driver, the control unit 40 controls the parking lock actuator 52 of the parking lock device 44, which in turn actuates the pawl 48 via the actuation mechanism 50. In the case of the tooth-on-tooth position shown in FIG. 2a, the biasing spring 54 is biased and the pawl 48 is pressed against the outer toothing 56 or one of the teeth 58 of the outer toothing 56 of the parking lock gear 46. The position detecting 36 now transmits the position of the parking lock gear 46 to the control unit 40.

The control unit 40 calculates the angle of rotation by which the electric motor 14 in the electric drivetrain 12 must rotate the rotor 32 or the rotor shaft 34 so that the nearest tooth space 60 of the outer toothing 56 of the parking lock gear 46 can engage with the pawl 48 or its pawl tooth 64.

The direction of rotation for the electric motor 14 is known in the control unit 40 by the fact that when the vehicle is parked on an incline, the electric motor 14 has delivered a torque before coming to a standstill. When passing a downhill section before the vehicle is parked, a drag torque was applied to the electric motor 14 by the vehicle movement.

Since the control unit 40 now knows the direction of rotation of the electric motor 14 and the angle of rotation for reaching the nearest tooth space 60, this position can now be approached in a precisely controlled manner, which corresponds to the state of FIG. 2b, in which a plunging movement 72 of the pawl 48 into the nearest determined tooth space 60 of the outer toothing 56 of the parking lock gear 46 has taken place.

During this process, it is not necessary for the driver of the electrically driven vehicle 10 to press the brake pedal. However, if the driver has applied the brake pedal out of habit and then released it again, the brake application or brake release is transmitted to the control unit 40, for example via a CAN bus in the electrically driven vehicle 10.

If the electrically driven vehicle 10 begins to move and a rotary movement is transmitted via the drive gears 22, 24, the drive shafts 18 and 20 to the transmission 16 and thus to the electric motor 14, this rotary movement is detected by the position detecting 36. The control of the further movement, i.e. the rolling of the electrically driven vehicle 10 into the parking lock device 44 via a corresponding control of the electric motor 14 in the electric drivetrain 12 can be carried out as described above.

The invention is not limited to the exemplary embodiments described herein and the aspects highlighted therein. Rather, a variety of modifications, which are within the scope of activities of the person skilled in the art, is possible within the range specified by the claims.

1. A method for rolling an electrically driven vehicle (10) into a parking lock device (44) from a position in which a pawl (48) is prevented from locking a parking lock gear (46), the method comprising:
a). biasing a biasing spring (54) by an actuator (52) when the parking lock device (44) is activated,
b). transmitting to a control unit (40) a position of a parking lock gear (46) accommodated in a rotationally fixed manner, sensed by a position sensing system (36),
c). determining an angle of rotation of a rotor shaft (34) of an electric motor (14) to reach a nearest tooth space (60) of an outer toothing (56) of the parking lock gear (46) and
d). actuating the electric motor (14) for sweeping the angle of rotation determined in accordance with c) and controlling an approach to a position of the nearest tooth space (60) determined in accordance with c).

2. The method according to claim 1, wherein a direction of rotation of the electric motor (14) for sweeping the angle of rotation determined according to c) is obtained from information as to whether the electric motor (14) has delivered a torque when the electrically driven vehicle (10) reaches a standstill position, or whether the electric motor (14) was rotated by vehicle movement before the electrically driven vehicle (10) reached the standstill position in a recuperation mode.

3. The method according to claim 1, wherein a rotary movement of the pawl (48) about an axis of rotation (62) is initiated by a translatory movement of an actuating mechanism (50).

4. The method according to claim 1, wherein the biasing of the biasing spring (54) according to a) adjusts a translationally movable slider (68) against an actuating surface (70).

5. The method according to claim 1, wherein the position of the parking lock gear (46) according to b) is detected by a position sensing system (36) configured as a resolver.

6. The method according to claim 1, wherein characterized during execution of method steps a) to d) the pawl (48) is held in a position set against the outer toothing (56) of the parking lock gear (46).

7. The method according to claim 4, wherein the pawl (48) remains locked by the slider (68) after engaging in the nearest tooth space (60) of the outer toothing (56) according to c).

8. The method according to claim 4, wherein the pawl (48) is released by a translatory movement of the slider (68) after renewed activation of the parking lock device (44) after a controlled rolling process into the latter.

9. A use of the method according to claim 1 for rolling an electrically driven vehicle (10) into a parking lock device (44) from a position in which a pawl (48) is prevented from locking a parking lock gear (46).
